(19) United States
(12) Patent Application Publication
(10) Pub. No.: US 2019/0257979 A1
(43) Pub. Date: Aug. 22, 2019

(54) FloodGraphic: A site and elevation specific flood history, warning, and data collection capable sign and a methodology for deployment of the sign

(71) Applicant: Michael William Hyland, Stuart, FL (US)

(72) Inventor: Michael William Hyland, Stuart, FL (US)

(21) Appl. No.: 15/898,568

(22) Filed: Feb. 22, 2018

(51) Int. Cl. G01W 1/10; G09F 13/22; H04W 4/90; G01B 7/26; G09F 27/00

(52) U.S. Cl. CPC G01W 1/10; G09F 13/22; G09F 2013/222; G01B 7/26; G09F 27/007; H04W 4/90

(57) ABSTRACT

The method of FloodGraphic graphically present location specific topographic and flood hazard data, including time-sensitive NWS watches and warnings inclusive of site-specific forecast flood depths via an array of particularly shaped and colored, site-specifically annotated, video-capable signs

The signs include vertical gradations in feet or meters in full scale presenting the elevation of the site, historic, and predicted future flood levels, specific to the location of each FG installation. FloodGraphic headquarters administers a program of information accumulation, vetting, information dissemination and management of installations.

The method achieves a standard nationwide array of warning signs.

The FloodGraphic method provides information and warning of actual past and forecast flood heights at a multiplicity of locations more effectively than any existing method by presenting data at each installation with reference to the grade level and a National Datum. No linking to or differentiation between the flood watch and flood warnings of the NWS is provided by any prior art.

### CROSS-REFERENCE TO RELATED APPLICATIONS

A Design Patent application, Ser. No. 29/629,258, has been filed by this applicant for the FloodGraphic (FG) signs; it presents and describes the appearance of the FloodGraphic series of signs. The static and dynamic versions of the signs, FG and FG-D, are the same in appearance until the onset of a Flood Watch or Flood Warning, issued by the National Weather Service. In the case of FloodGraphic-Dynamic (FG-D), the capabilities of data collection and interactive communication enable updating of graphics, provision of time-sensitive warnings of impending flood events, and communication of the elevation of flooding events as they transpire to FloodGraphic Headquarters (FG HQ).

### STATEMENT REGARDING FEDERALLY SPONSORED RESEARCH OR DEVELOPMENT

There are no government license rights to this invention. This invention has not been made with government support.

### NAMES OF THE PARTIES TO A JOINT RESEARCH AGREEMENT

There is no joint research agreement.

### REFERENCE TO A SEQUENCE LISTING

There is no reference to a sequence listing. No text files have been filed via EFS-web. PDF-A files have been filed via EFS-web as listed in the Image File Wrapper and are incorporated herein by reference.

### STATEMENT REGARDING PRIOR DISCLOSURES BY INVENTOR OR JOINT INVENTOR

The inventor has disclosed that the patent application for the invention is pending. Parties to whom the disclosure has been made include: the corporations Planar, Sharp, R Ink Holdings, Google, and IBM, the US government agency National Weather Service, the publications Natural Hazards, Journal of Insurance Regulation (JIR), National Association of Insurance Commissioners, Wells Media Group, Insurance & Technology Environmental Research Letters, Journal of Coastal Research, Journal of the American Planning Association, Natural Hazards Review, personal acquaintances, and family.

### BACKGROUND OF THE INVENTION

### Field of the Invention

CPC: Y02A 10/00; G09F15/005, Y02A 90/32

IPC:; G08B 27/00

### Pre-Examination Search

A pre-examination search has been conducted. U.S. Class is understood to be no longer used and retired as of December 2015. The USPTO has added CPC symbols to all its published documents going back to 1836. This was accomplished via an electronic concordance system and the degree of accuracy is yet unproven. International Class is understood to be nearly synonymous with CPC.

The field of search includes the following CPC Classes; formatting within this list is as in the USPTO Cooperative Patent Classification

(www.uspto.gov/web/patents/classification/cpc):

B PERFORMING OPERATIONS; Transporting
B44 Decorative Arts
B44F Special Designs or Pictures
B44F 1/100 Designs or Pictures characterized by special or unusual light effects

E FIXED CONSTRUCTIONS
E04H 12/00 Towers; Masts or poles; Chimney stacks; Water-towers; Methods of erecting such structures

F MECHANICAL ENGINEERING; LIGHTING. . . .
F15B Systems Acting By Means Of Fluids In General; Fluid-Pressure Actuators
F15B 13/085 . . . {Electrical controllers}
F15B 13/0853 {Electric circuit boards}

G: PHYSICS
G01: Instruments Measuring; Testing
G01C: Measuring Distances, Levels Or Bearings; Surveying; Navigation;
Gyroscopic Instruments; Photogrammetry Or Videogrammetry
G01F measuring liquid level
G01W 2203/00:
G01W 2201/00: Weather detection, monitoring or forecasting for establishing the amount of global warming
G01W 2203/00: Real-time site-specific personalized weather information, e.g. nowcasting
G02 Optics:
G02F; Electro-, Magneto- Or Acousto-Optic Display Devices
G05
G05B 15/02
G05B 19/0428
G05B 23/0235
G06Q 50/16
G06 Computing; Calculating; Counting
G06F
G06Q
G06M Counting Mechanisms; Counting Of Objects Not Otherwise Provided For
G06Q 10/0635
G06Q 50/06
G06Q 50/16
G08: Signalling
G08B: Signalling Or Calling Systems; Order Telegraphs; Alarm Systems
G08B 5/00 Visible signalling systems, e.g. personal calling systems, remote indication of seats occupied {(locks with visible signalling devices E05B 39/00; electro-, magneto- or acousto-optic display devices G02F; display tubes H01J 17/49, H01K
G08B
7/04; electro-luminescent devices H05B 33/00)}
7/06
G08B Signalling Or Calling Systems; Order Telegraphs; Alarm Systems
G08B21/10:
G08B 21/182 . . . {Level alarms, e.g. alarms responsive to variables exceeding a threshold}
G08B 27/00 Alarm systems in which the alarm condition is signalled from a central station to a plurality of substations {(signalling systems in general G08C)}
G08B 27/005. {with transmission via computer network}
G08B 27/006. {with transmission via telephone network}
G08B 27/008. {with transmission via TV or radio broadcast}
G08B 29/04
G08B 31/00 Predictive alarm systems characterized by extrapolation or other computation using updated historic data
G09: Education; Cryptography; Display; Advertising; Seals
G09F Displaying; Advertising; Signs; Labels Or Name-Plates; Seals
G09F 9/00: Indicating arrangements for variable information in which the information is built-up on a support by selection or combination of individual elements
G09F15/005 . . . (for orientation or public information)
G09F 19/12
G09F 13/005
G09F 13/005. {Illumination controller or illuminated signs including an illumination control system}
G09F 2013/0431 {connected to a pole}

H ELECTRICITY
H01L Semiconductor Devices; Electric Solid State Devices Not Otherwise Provided For
H04 Electric Communication Technique
H04L 65/102
H04W Wireless Communications Networks
H04W 4/22. {Mobile application service} emergency connection handling {or mobile application services handling urgent or hazardous situations, e.g. 3GPP earthquake and tsunami warning system

Y GENERAL TAGGING OF NEW TECHNOLOGICAL DEVELOPMENTS; GENERAL TAGGING OF CROSS-SECTIONAL TECHNOLOGIES SPANNING OVER SEVERAL SECTIONS OF THE IPC; TECHNICAL SUBJECTS COVERED BY FORMER USPC CROSS-REFERENCE ART COLLECTIONS [XRACs] AND DIGESTS YO2A TECHNOLOGIES FOR ADAPTATION TO CLIMATE CHANGE
Y02A 10/00 at coastal zones; at river basins
Y02A 10/30 Flood prevention; Flood management or accommodation; Storm water management
Y02A 10/40 Monitoring; Forecasting; Planning
Y02A 10/41 . . . of coastal areas
Y02A 90/00 Technologies having an indirect contribution to adaptation to climate change
Y02A 90/10 Information and communication technologies [ICT] supporting adaptation to climate change.
Y02A 90/32 based on topography, e.g. mapping, location, large scale investigation of water resources or satellite or aerial imagery Y10S
Y10S

### Description of Related Art

Beginning in September 2017 Applicant has searched for US patents and pending US patent applications in CPCs listed above, utilizing USPTO and Google Patent data as available on the web. Search of “Flood AND Warning AND Sign” using Google Patent and the USPTO search function revealed the following prior Patents, pending Applications, and related literature, which upon review do not contain the elemental aspect of this Application: the presentation of warning data in graphic format and with respect to the actual elevation of the ground at the site of the warning sign/device. The method of FloodGraphic does include concepts embodied in prior art—a database, interactive communication capabilities between the electronic version of the signs, FG-D, and the headquarters. FG HQ, and communication between FG HQ and government entities, which provide historic data and future flood warnings relative to general location and general flood elevations, in a variety of terms as to reference datums. But no prior art to this applicant's knowledge includes precise location and elevation-specific warnings as is producible through FloodGraphic's array of site elevation specific referencing signs.

### Patents

U.S. Pat. No. 6,816,878

This is a comprehensive warning data accumulation & transmission system

It describes:
“[a] subscriber information table 184, the table includes fields for identifying information regarding the subscriber that can be used to determine whether the subscriber ought to be notified of a given alert condition. These fields include a field 208 for storing a postal zip code for the subscriber, a field 210 for storing the county identifier for the subscriber, a field 212 for storing a state identifier for the subscriber and a field 214 and a field 216 for identifying a latitude and longitude for the subscriber. Fields 208 through 216 identify at varying levels of specificity the geographic location of the subscriber so that the subscriber can be selected for receipt of a notice under the appropriate conditions. . . .
A field, 222, is used to store an elevation at the subscriber's location and a field, 224, is used to store a flood zone code for the subscriber. These fields will be used to identify whether the subscriber is subject to alert notifications relating to floods or weather conditions that only affect certain elevations or flood zones.”

It is devoid of a site location and elevation specific graphic warning of depths of flood.

U.S. Pat. No. 8,614,631

The “totem” in this patent is a means by which citizens are told of phone numbers to report observations of flooding events; it provides no warning information to observers nor does it provide information with respect to historic flooding.

From the patent:
“As also depicted in FIG. 1, a totem display can additionally include an area number to be used by citizens if directly contacting an Emergency Call Center (for example, 911), enabling the citizen to be precise about his/her location. Totem displays can also include calling numbers and SMS addresses that enable a citizen to automatically provide information to a Flood Management Center (or call center) about position and flooding levels without the need for human operators. Further, the totem displays can include information about how to register (for example, by phone or Internet) a phone number to receive warnings for the particular area in question.”

U.S. Pat. No. 8,614,631 Dec. 24, 2013, Pinhanez, Flood data collection and warning mechanism

The system relies upon observers of flooding in the field to recognize and rely upon “totems” and to place a telephone call or send a text upon observation of flooding to a color-band level, which level indicates the number to call/text. The graphics of the “totems” is undeveloped. The system provides no historic flood data and no warning information. The observer/reporter must be observing the flood to input data to the system. Warnings are transmitted to beneficiaries via telephone &/or text. The “totems” serve no warning function. There is no explicit use of a unifying vertical datum/reference plane.

U.S. Pat. No. 9,247,408 Jan. 26, 2016, South, Interactive emergency information and identification, H04W 4/22

This claims a computer implemented method for interactive emergency information and identification. Information transmission is via the computer processor; there is no visual information on the actual ground.

### Nonpatent Literature

Search terms for nonpatent literature have included those below listed with relevant returns presented by hyperlink of the relevant return' all have been uploaded via EFS-Web.

### Discussion of Relevant Non Patent Information

Scrimsign Vehicle Activated Flood Warning Signs

http://www.scrimsign.co.uk/Uploads/users/scrimsign/0k4b5fr9cl8c0lkclacq9ghbl1/2014/11/12/7fe4utJl_scrimsign_flood_warning.pdf. This product is triggered by telemetric data, and warns of flooding at roadway fords (stream crossings). The sign is location specific to a given ford, but not elevation specific. The functionality is limited to “Flood/no Flood”. No precise location specific elevation data, historic flooding data, or elevation range of forecast flooding is provided.

Georgia, USA Flood Warning Sign

http://www.fema.gov/media-library/assets/images/56090

This sign incorporates the MUTCD warning sign design, and speaks to an general area of historic flooding, but does not present precise location specific elevation data, historic flooding data, or elevation range of forecast flooding.

NWS/NOAA “Turn Around Don't Drown®” Signs

http://tadd.weather.gov/

These signs incorporate the MUTCD vernacular, and discourage motor vehicle drivers from entering waters of unknown depth, but do not present precise location specific elevation data, historic flooding data, or elevation range of forecast flooding.

Philippine Atmospheric Geophysical and Astronomical Services Administration (PAGASA) Color-Coded Rainfall and Flood Warning System

http://www.gmanetwork.com/news/scitech/science/267638/the-color-of-danger-pagasa-s-new-rainfall-and-flood-warning-system/story/

The system is triggered by rainfall amount forecasts and incorporates the 3 primary colors, red, yellow, green in the traditional way. It does not incorporate location data (latitude, longitude and elevation with respect to any national vertical datum) specific to the precise site of installation, based on the available materials reviewed.

The Adoption and Implementation of Hazard Mitigation Policies and Strategies By Coastal Jurisdictions in Texas . . .

At page 33, the publication indicates that of responsive coastal jurisdictions in Texas 74.2% made no use of hazard zone signs in information dissemination/awareness programs:
“4.6 information dissemination and awareness programs hazard information and awareness programs offer a mechanism through which land use practices and patterns might be altered voluntarily. The hope is that as residents, builders, developers and others gain a better understanding of their hazard exposure and risk they will make adjustments that will enhance the mitigation status of an area. 5 strategies were asked of local jurisdictional informants concerning a variety of information dissemination and awareness policies and programs. These programs include: 1) public education for hazard mitigation, 2) citizen involvement in hazard mitigation planning, 3) offering seminars on hazard mitigation practices for developers and builders, 4) hazard disclosure statements as part of real estate and other transactions, and 5) the use of hazard zone signage. The table 4.7 displays the various responses for each strategy. . . .
. . . The least popular strategy that might be employed to increase public awareness of hazard is signage clearly indicating hazard of the zones or areas. Only 2.4 of jurisdictions report using hazards signage extensively, 9.7 of jurisdictions employ them somewhat and nearly 14% use them sparingly. The vast majority of just over 74% never use hazards signage in their jurisdictions.
It is interesting that while information dissemination and awareness tools are known to be relatively inexpensive yet effective measures for promoting mitigation adjustment, especially voluntary adjustments, these policies are not being extensively implemented by local jurisdictions along the Texas coastal areas. It is also interesting to note that these general findings stand in stark contrast to the observation that education programs are often proposed actions in the coastal hazard mitigation plans evaluated by Peacock and colleagues (2009) however, many stakeholders, particularly those in the “development” community, often shun programs like disclosure statements and signage that make very obvious hazard exposures for areas within local jurisdictions.”

“Avoiding Coastal Hazard Areas: Best State Mitigation Practices”)

The authors
“. . . review mitigation programs primarily directed at increasing avoidance of hazard areas through 4 means: (1) hazard area definition, (2) hazard notification, (3) restriction of public subsidies, and (4) hazard area acquisition. . . .
Hazards notification warns potential purchasers of property about where they can expect to encounter hazards, so that they may avoid them or take other mitigation measures, . . . ” (page 13)

The authors discuss Hazards Notification and indicate:
“research indicates that the methods of notification (timing and materials) as well as the perceptions about notification created by the professionals involved in the process have the greatest influence on notification effectiveness” [references cited omitted here for brevity] . . . Ideally, notification should occur when the purchaser begins evaluation of the properties available for purchase (not during preparation of or just prior to execution of the contract to purchase, because the purchaser becomes committed to making an offer without the opportunity to fully consider hazard conditions). The purchaser must understand the notification message (Palm, 1982)”

The authors describe “best notification practices” and indicate:
“Based upon a review of state experience in literature on hazards notification, 5 factors appear to influence notification effectiveness: (1) timing and material of the disclosure message; (2) purchaser understanding of the notification message; (3) perceptions of the professionals involved in the purchase decision; (4) availability of adequate data to implement the program; and (5) strong enforcement provisions.
Recommended best practices in the design of a coastal hazards notification program need to be framed around these factors:
   provide notification as early as reasonably possible, ideally when the purchaser begins to evaluate properties available for purchase.
   Notification should be clear and direct, identifying the nature of hazard conditions and their potential impact on property, and he provided insufficient detail for the purchaser to understand its contents. Model disclosure statements and manuals that explain hazards in layman's language also should be distributed to the public.
   Professionals involved in the notification process (e.g., lenders, real estate agents and brokers, and attorneys) should be educated about the meaning and importance of the notification through educational materials and seminars.
   Sufficient data should be made available to the public including maps or other forms of information identifying land subject to hazards so that the program can be easily and efficiently administered. . . .”

FEMA Integrated Public Alert & Warning System (IPAWS)

The Federal Emergency Management Agency (FEMA) has developed IPAWS-OPEN which system upon further development and integration with FG is compatible with the FG specification. FG in the ideal scenario will be integrated into IPAWS-OPEN [from HTTPS://www.FEMA.gov/integrated-public-alert-warning-system])
“IPAWS systems include emergency alert system (EAS), wireless emergency alert (WEA), NOAA weather radio (NWR) and Internet Systems. IPAWS infrastructure includes national public warning system (and PWS) (private or commercial radio broadcast stations . . . ) And IPAWS open platform emergency networks (IPAWS-OPEN).”
The website indicates under the heading integrated Public alert & warning system open platform for emergency networks:
“. . . IPAWS-open receives and authenticates messages transmitted by alerting authorities and routes them to IPAWS-compliant public alerting systems. Software and hardware developers are creating IPAWS-open compatible alert origination and dissemination tools for emergency management officials that allows messages to travel to the public via radio, television, cell telephone, NOAA weather radio, Internet-based systems, and other dissemination systems.
Private-sector manufacturers of emergency alert system (EAS) encoder/decoder equipment have updated their products to be capable of receiving hearts from IPAWS-OPEN. IPAWS uses the common alerting protocol (CAP), an international standard developed by Organization for the Advancement of Structured Information Standards (OASIS) and FEMA, in cooperation with private-sector developers. Existing state or locally owned and operated warning systems-such as sirens, highway signs, or emergency telephone notification systems-can be designed to integrate alerts from IPAWS-OPEN.
Who may use IPAWS-OPEN
. . . Private or public sector developers can access, at no charge, the IPAWS test and development environment for the purpose of designing IPAWS-OPEN compatible systems. Private or public sector developers can also access, at no charge, the IPAWS all-hazards information feed of live alerts issued by government organizations for the purpose of redistribution and/or situational awareness.”

FG is to be an IPAWS-OPEN compatible system.

Big Thompson flood disaster Final report to the governor of Colorado)

(uploaded via EFS-Web May 16, 2018, part 2 of two parts, Part 1 of 2 parts)

The report indicates under the subheading “CRITERIA FOR AN EFFECTIVE WARNING SYSTEM”:
“Despite the sophistication of the prediction network, if planning for the flood hazard does not include careful consideration of warning dissemination, warning content, and other variables that influence response to the warnings, the system may foil its major purpose: safe evacuation of vulnerable areas.” (Page 11-3)

Under the subheading “Design Parameters”:
“Of practical importance in the design of a warning system or the variables related to the characteristics of warning. These include the reliability of the detection network, the credibility of the warning, the nature of the communication mode, the content of the message, confirmation of the warning, the number of warnings received, and the public awareness of the hazard. Other important variables include the presence of physical evidence that a potential for flooding does exist, e.g. heavy rainfall, rising river levels, or a history of flooding.” [Emphasis (italics) added]

The report indicated the following as to signs:
“Signs advising people a flash flood hazard and directing them to climb the Canyonside in the event of a flood should be placed at strategic points in the canyon. This is been done in the big Thompson Canyon, Boulder County Canyons and other streams. After evaluating this signing program, the state highway department will consider placing warning signs and other hazardous Canyons in Colorado. Signs may also be directed that indicate the expected limits and heights of flooding”

### Conclusion From Non-Patent Literature Search

While multiple means of flood warning exist, none incorporate signage which incorporates location data (latitude, longitude and elevation with respect to NVGD) specific to the precise site of installation. No allusions or references to such methodology have been discovered.

Costs Attributable to Flooding are Huge; yet damage/ loss is highly location-specific Hurricanes Katrina (2005, $160 billion) and Harvey (2017, $125 billion) together cost over one quarter of $1 trillion in 2017 dollars according to the National Hurricane Center's Costliest U.S. tropical cyclones tables updated (from https://www.nhc.noaa.gov/news/UpdatedCostliest.pdf

According to Wikipedia (https://en.wikipedia.org/wiki/Hurricane_Harvey:
“Hurricane Harvey is tied with Hurricane Katrina as the costliest tropical cyclone on record, inflicting at least $125 billion (2017 USD) in damage, primarily from catastrophic rainfall-triggered flooding in the Houston metropolitan area. . . .

Economic loss estimates
Moody's Analytics initially estimated the total economic cost of the storm at $81 billion to $108 billion or more; most of the economic losses are damage to homes and commercial property. [104] Reinsurance company Aon Benfield estimated total economic losses at $100 billion, including $30 billion in insured damage, making Harvey the costliest disaster in 2017 by their calculations.[105] USA Today reported an AccuWeather estimate of $190 billion, released August 31. [106] On September 3, Texas state governor Greg Abbott estimated that damages will be between $150 billion and $180 billion, surpassing the $120 billion that it took to rebuild New Orleans after Katrina. [107] [108] According to weather analytics firm Planalytics, lost revenue to Houston area retailers and restaurants alone will be approximately $1 billion. The Houston area controls 4% of the spending power in the United States. [109]

In September 2017, the Insurance Council of Texas estimated the total insured losses from Hurricane Harvey at $19 billion. This figure represents $11 billion in flood losses insured by the National Flood Insurance Program (NFIP), $3 billion in “insured windstorm and other storm-related property losses”; and about $4.75 billion in insured flood losses of private and commercial vehicles. [110] By Jan. 1, 2018, payouts from the NFIP reached $7.6 billion against total estimated losses of $8.5-9.5 billion. [111] Economists Michael Hicks and Mark Burton at Ball State University estimated damage in the Houston metropolitan area alone at $198.63 billion. [112] Preliminary reporting from the National Oceanic and Atmospheric Administration set a more concrete total at $125 billion, making Harvey the 2nd costliest tropical cyclone on record, behind Hurricane Katrina with 2017 costs of $161 billion (after adjusting for inflation).[2]
A significant portion of the storm's damages are uninsured losses. Regular homeowner insurance policies generally exclude coverage for flooding, as the NFIP underwrites most flood insurance policies in the US. [113] [114] Although the purchase of flood insurance is obligatory for federally guaranteed mortgages for homes within the 100-year flood plain, enforcement of the requirement is difficult and many homes, even within the 100-year flood plain, lack flood insurance. [113] In Harris County, Tex.—which includes the city of Houston—only 15% of homes have flood insurance policies issued by the NFIP. Participation in the NFIP is higher, but still low, in neighboring Galveston (41%), Brazoria (26%), and Chambers Counties (21%). [113] Homeowners sued authorities after reservoir releases damaged homes. [115] . . . ”
[References [annotated within brackets above] have been omitted]

From http://www.iii.org/fact-statistic/catastrophes-us:
“NATURAL CATASTROPHES
Insured losses due to natural disasters in the United States in 2016 totaled $23.8 billion, according to Munich Re, more than the $16.1 billion total for 2015 . . . Floods and flash floods accounted for $4.3 billion in insured losses in 2016, and tropical cyclones accounted for $3.5 billion in insured losses. . . .
2016 AND 2017 NATURAL AND MAN-MADE CATASTROPHES The first quarter of 2017 was the costliest first quarter in terms of losses for the property/casualty insurance industry since 1994, the year of the Northridge, Calif. earthquake, according to the Property Claim Services (PCS) division of Verisk Analytics. In the first quarter of 2017 insured catastrophe losses totaled $7.3 billion dollars, $2.3 billion higher than first-quarter 2016 . . . ”

The NY Times headline. “Car Owners Inundate Insurers With Claims After Hurricane Harvey” (https://www.nytimes.com/2017/08/31/business/car-insurance-storm.html?_r=0) (uploaded via EFS-Web May 15, 2018) is a reminder of the frequency of catastrophic property loss attributable to floods.

The Times' Nov. 11, 2017 story with accompanying map identifying the locations of buildings damaged by Hurricane Harvey in 2017 shows the dendritic pattern of areas of building damage in the context of FEMA's 100 year floodplain. (This article is available at https://www.nytimes.com/interactive/2017/11/11/climate/houston-flooding-climate.html) (uploaded via EFS-Web May 15, 2018)) The same article indicates that since 1980, instances of extreme weather . . . Have cost the United States $1.1 trillion and that studies show that for every dollar spent up front and preparedness, American taxpayers could save $4 in emergency relief and reconstruction—not counting health costs, the impact of lost jobs in business revenues and incalculable grief.

Datum Confusion Exists Within the General Public

National Flood Insurance Program (NFIP) Flood Insurance Rate Maps (FIRMS) (notes only Uploaded via EFS-Web May 15, 2018) are based on the Datum stated on each FIRM:
“Flood Insurance Rate Maps (FIRMs) reference the vertical datum used to compute flood elevations. In completing Elevation Certificates, which are used to determine the proper flood insurance premium rate, and/or to support a request for a Letter of Map Amendment or Letter of Map Revision Based on Fill, the same vertical datum as that shown on the FIRM must be used to compute lot and/or structure elevations and to compute flood elevations that are not given on the FIRM.” -https://www.fema.gov/engineers-surveyors-and-architects-frequently-asked-questions#en9 (answer to question 16)) (uploaded via EFS-Web May 15, 2018)

FIRM 34009C0089F Effective Oct. 5, 2017 (notes only from FIRM 34009C0089F Uploaded via EFS-Web May 15, 2018) (an exemplar used for discussion as it is one with which the applicant is familiar) specifies:
“Flood Elevations on this map are referenced to the North American Vertical Datum of 1988. . . .” [NAVD88]

BFEs are not Representative of Common Floods

FIRM 34009C0089F also specifies:
“To obtain more detailed information in areas where Base Flood Elevations (BFEs) and/or floodways have been determined, users are encouraged to consult the Flood Profiles and Floodway Data and/or Summary of Stillwater Elevation tables contained within the Flood Insurance Study (FIS) report that accompanies this FIRM. Users should be aware that BFEs shown on the FIRM represent rounded whole-foot elevations. These BFEs are intended for flood insurance rating purposes only and should not be used as the sole source of flood elevation information. Accordingly, flood elevation data presented in the FIS report should be utilized in conjunction with the firm for purposes of construction and/or floodplain management” [emphasis (bold text) as in the original)

FIS May Not Contain Community Repositories of Flood Hazard Data

The FIS for Cape May County N.J., Flood Insurance Study Number 34009CV000A effective Oct. 5, 2017, version number 2.1.3.0) indicates:
“NOTICE TO FLOOD INSURANCE STUDY USERS
communities participating in the NFIB have established repositories of flood insurance data for floodplain management and flood insurance purposes. This flood insurance study may not contain all data available within the repository it is advisable to contact the community repository for any additional data.”

Using Ocean City, N.J. as an example, the City has provided historic flood data (online at the community website)) (uploaded via EFS-Web May 15, 2018) in substantially greater detail than is found in the FIS, as is seen in this table (datum is NAVD88):

| | | | Flood |
|---|---|---|---|
| | | | Height-City |
| Date | Name | Flood Height-FIS | Data |
| Oct. 27-29, | hurricane Sandy | 5.8 (Cape May) | 7.25 |
| 2012 | | 6.3 (Atlantic City | |
| | | 10.4 (Sandy Hook) | |
| Sep. 14, | Great Atlantic | not reported | 6.65 |
| 1944 | Hurricane | | |
| Mar. 6-8, 1962 | March “Ash | not reported | 6.35 |
| | Wednesday” storm | | |
| | 1962 | | |
| Dec. 11, 1962 | storm | | 6.23 |
| Oct. 31, 1991 | [? Hurricane] | 6.00 | |
| Sep. 27, | hurricane Gloria | | 5.75 |
| 1985 | | | |
| Jan. 23, 2016 | Storm Jonas | | 5.60 |
| Aug. 28, 2011 | Hurricane Irene | 5.5 (Cape May) | not reported |
| Nov. 11-14, | Storm | | 5.25 |
| 2009 | | | |

The FIS speaks to an Aug. 26-28, 1971 flood as a consequence of a heavy frontal storm in combination with Tropical Storm Doria, and indicates “an extensive high watermark survey was conducted jointly by the state of New Jersey and the USGS following Doria”. These data are on file with the NJ DEP Division of Water Resources”, but the data is not included in the FIS. This statement is included here only as an exemplar of the fact that aggregation of historic flood data requires searching multiple sources, and is not easily accomplished.

Data is Location Specific

It is well known that historic flood information is highly location-sensitive, and methods of utilization of record information to inform the public about future risk are inherently approximate. It is argued here that approximations derivative from this fact are and an acceptable consequence of the benefits that will accrue.

Need for the Product/Service

Computer and electronic data systems abound for detection and warning of floods, yet losses continue to stagger the imagination. The problem is asserted to be in part the lack of a simple means of communicating flood related history and location specific warnings of depth of floods to the public. Losses within any given environ are highly location specific, owing in preponderant part to variations in local topography. Simply put, in any given flood, the high ground is safer than the low ground. The public within a given community is often unaware of and insensitive to the subtle variations in topography that can make one site experience multiple feet of flood waters, while another site only a block or 3 away might experience no flooding whatsoever. This differentiation ofttimes is fresh in the minds of the public in the immediate aftermath of a storm but fades from memory as time passes.

No warning method or system in existence presently communicates the vertical extent of historic or forecast future flooding above the ground at a specific location.

No warning method or system in existence sets forth the actual elevation of the site as determined by a professional engineer or land surveyor, and historic and future flood levels, or in the FloodGraphic-Dynamic version time-sensitive warning information.

FloodGraphic signs, dispersed in a block by block grid in flood sensitive communities, will provide graphic evidence of the variability of depths of historic & threatened flooding and highlight the variability of flood depths attributable to subtle topographic variations that are commonplace, but too slight to be familiar even to neighborhood residents. This will provoke the moving of cars and other valuables from flood prone sites to less flood prone sites, which are often only a block or two away. It will expand knowledge of the locations of extremely flood prone sites and sites of lesser flood propensity. Such expanded knowledge will positively affect decision making re: building and home purchases, development, and redevelopment, and even where one parks one's car, in such communities. In the aggregate, FloodGraphic will enhance sensitivity to flooding and reduce flood related losses.

An array of FloodGraphic signs in a flood prone community will serve to provide a continuous reminder of which areas are relatively hazardous and which areas are relatively safe.

### BRIEF SUMMARY OF THE INVENTION:

The Purpose of the FloodGraphic (FG) method invention is to educate the public in flood prone communities as to the time and location-specific variability of flood depths within such communities, and to thus enable them to act so as to minimize their risk and damage to their property as a consequence of flooding. Through the standardization of the FG method, FG signs will become recognizable throughout the country. This recognition will enhance safety and reduce risk.

FloodGaphic is a method of communication of historic flood data, the level of the forecast 100 year flood, and the site-specific level of flooding forecast by US government flood warnings and watches via visual display of graphics and text data on an array of site location and elevation specific, particularly and consistently formatted outdoor signs created by a centralized, controlling organization.

The method includes the centralized controlling organization, FloodGraphic Headquarters (FG HQ). FG HQ designs the signs, sources and vets flood data for the signs, manufactures, determines appropriate specific locations and the related location-sensitive data to be presented in text and graphic form upon each individual sign, distributes, and manages installation and maintenance of the signs. Site-specific historic flood levels and time-sensitive warning data is sourced by FG HQ from government records at every level of government and from private sources. Data is vetted to eliminate outliers. FG HQ maintains a database of installed locations and post-installation flood history.

All depth of flood warnings are reduced to a common datum to eliminate confusion that arises as a consequence of the use of local mean low water in weather reporting versus NGVD used by FEMA/NFIP in FIRMS.

FG HQ retains Licensed Land Surveyors, Engineers and/or Architects engaged in preparation of FEMA Elevation Certificates to determine the appropriate installation locations and site elevations relative to the National Vertical Geodetic Datum (NVGD) and to provide this data, as well as the particulars of the installation site (e.g., a street sign, a building corner) to FG HQ.

The signs may be of either fixed display, without electronic functionality, titled FloodGraphic (FG), in which case no electronic communication capabilities exist, or inclusive of an array of electronic functionalities, titled FloodGrapic-Dynamic (FG-D). FG-D signs include electronically variable displays, are capable of flood event detection and wireless electronic communication. Time, duration and depths (to include wave heights) of flood are communicated by the FG-D signs to FG HQ. The passage of time and recurring flood events will result in a collection of data suitable for use in future forecasting and will increase the future efficacy of real time flood depth forecasts. FG HQ communicates changes in static display data, flood watches and flood warnings issued by the National Weather Service to the FG-D signs.

FG-D is solar powered, includes an embedded battery, is dynamically illuminating via Solid-state lighting (SSL), Solid State Electronically controlled, communicates wirelessly with FG HQ via wireless cellular and/or satellite communication systems, and presents variable text and color data via Solid-state lighting (SSL) with printed Flexible OLED light, or other imbedded light emitting technology. FG-D senses flood levels via embedded electronic sensors. Graphics are variable, to include variations in text, color and configuration to reflect changes in data and imminent warnings.

FG HQ electronically communicates Flood Watches and Warnings issued by National Weather Service to FG-D signs. FG-D signs present time-sensitive flood watch and warning data visually to the public. In the method of the FG warning system, FG HQ causes the FG-D signs to transition in color from yellow to red from the ground up to the forecast flood level in a repetitive fashion to provide time sensitive warnings based on National Weather Service data.

FEMA's IPAWS-OPEN system (see https://www.fema.gov/media-library/assets/documents/25845) will integrate with FG HQ, and potentially subsume it. FG HQ integrates with IPAWS-OPEN system to activate the FG-D signs. FG HQ uses the Common Alerting Protocol (CAP), an international standard developed by Organization for the Advancement of Structured Information Standards (OASIS) and FEMA, in cooperation with private-sector developers.

The method of FloodGraphic (FG) upon implementation in flood prone communities will facilitate effective flood warning by visually presenting in an array of consistently formatted signs the location specific variability of the elevation (the level above the ground) of the 100 year flood, historic flood information, and flood watches and warnings in a topographically sensitive format. Through exposure to the sign array within a given community, in scale, in a vertical display extending from the ground at each sign installation, the public will recognize and distinguish high risk/high depth sites (colored yellow from the ground up to a high level) from lower risk/lower depth sites (where the yellow to green transition is close to the ground, or even the sign is all green), and make decisions ranging from where to buy a house to where to park their car with greater sensitivity to flood risk.

### BRIEF DESCRIPTION OF THE SEVERAL VIEWS OF THE DRAWINGS

FIG. 1 (sheet 1 of 5) is an elevation view of a typical FloodGraphic sign.

It is not a structure but rather is a display, printed on a suitable media if fixed, or thin film electronic media in the electronic version. It It comprises a vertical placard approximately 3 inches in width, or diameter if in a cylindrical application, and of thickness, if planar, as necessary to comprise sufficient structural strength to resist natural forces and vandalism. In the planar version it may be mounted on an existing signpost or sign pole. If freestanding, it may be mounted upon a cylindrical pole, a rectangular tubular pole, or other geometric shape providing structural support. The width and graphics may vary if the target audience (e.g., motorists on a roadway) would require larger graphics to achieve comprehension. The height of each FG sign is dependent on the flood hazard statistics particular to each installation and is variable to achieve complete display of relevant topographic and flood hazard data.

The vertical scale and gradations are specific to each site with the grade elevation corresponding to the actual NVGD elevation of the ground at the base of the sign.

FIG. 2 (sheet 2 of 5) illustrates a typical FloodGraphic sign as might be viewed by residents/visitors of the community in which an array of such signs are located.

FIG. 3 (sheet 3 of 5) illustrates how surveyors utilizing conventional field survey equipment might determine site elevations in advance of preparation of site-specific data to include the elevation where a particular sign might be installed, which data would be communicated with the FloodGraphic Headquarters witch prepares the site-specific data to be presented on the particular sign configured for the specific location.

FIG. 4 (sheet 4 of 5) illustrates the organizational aspects of the FloodGraphic method any interactive relationships between FloodGraphic Headquarters, entities with which it interacts, and the array of FloodGraphic signs.

FIG. 5 (sheet 5 of 5 illustrates electronic communication paths between FloodGraphic Headquarters the FloodGraphic-Dynamic signs and the governmental agencies. It additionally depicts the electronic components contained within the thin-film electronically printed FloodGraphic-Dynamic signs.

### DETAILED DESCRIPTION OF THE INVENTION

FloodGraphic is a method of communicating the spatial variability of flood zone information, particularly the physical elevation or height above the ground of the 100 year flood and historic flood data with respect to the height above the ground within a flood prone community through an array of signs at multiple locations, which signs are produced, installed, monitored, and managed by a central headquarters, FloodGraphic Headquarters (FG HQ).

By virtue of a multiplicity of such signs within a given flood prone community, residents and visitors to such communities are exposed to graphic information that quickly and perceptibly communicates the risk of flood within the community, and especially the variability of such risk derivative from variations in topography.

In the event of issuance of flood warnings and or flood watches by US government agencies, the FloodGraphic-dynamic version of the FloodGraphic signs, under management of FG HQ will communicate via video like changes in appearance, the height above the ground to which floodwaters are forecast at each specific location of each FloodGraphic sign, thereby reinforcing public awareness of the variability of flood risk derivative from variations in topography.

The FloodGraphic method of flood warning provides education to the public of flood history and future flood risk as a function of local topography. It provides warnings of past floods and, in the case of FloodGraphic-Dynamic, communicates forecasts of future floods which forecasts and warnings are location and depth specific. No warning system in existence presently communicates the vertical extent of historic or forecast future flooding above the ground at a given specific location. No warning system in existence sets forth the actual elevation of the site as determined by a professional engineer or land surveyor, and historic and future flood levels, or in the Dynamic version, time- and location-specific depth of flood warning information.

As a consequence of deployment of FloodGraphic and FloodGraphic-Dynamic within flood sensitive locales the public will suffer fewer losses, and thus save money. Insurers and governments will likewise suffer fewer losses and save money. Social disruptions as a consequence of flooding will be reduced. Recovery periods as a consequence of flooding will be shortened.

Examination of FEMA FIRMS shows that the level of flood waters varies over distances within which considerable topographic variations exist, resulting in depths of flooding within an area of flooding that varies strictly as a consequence of topography. Closely spaced FloodGraphic signs serve to communicate that variation to the public, enabling a perception of locations of greater and lesser susceptibility to flooding within a given flood area.

Such variations in topography are frequently known only to those with long experience with flooding in a given flood prone community; visitors, particularly visitors in resort communities, which resort communities are commonly proximate to sea coasts, estuaries and rivers, are often unaware of the variability of flood risk derivative from variations in topography within a small geographic area which are revealed by the implementation of the FloodGraphic sign array.

The method of the FloodGraphic visual flood warning system incorporates 2 interdependent embodiments:

The FloodGraphic Signs

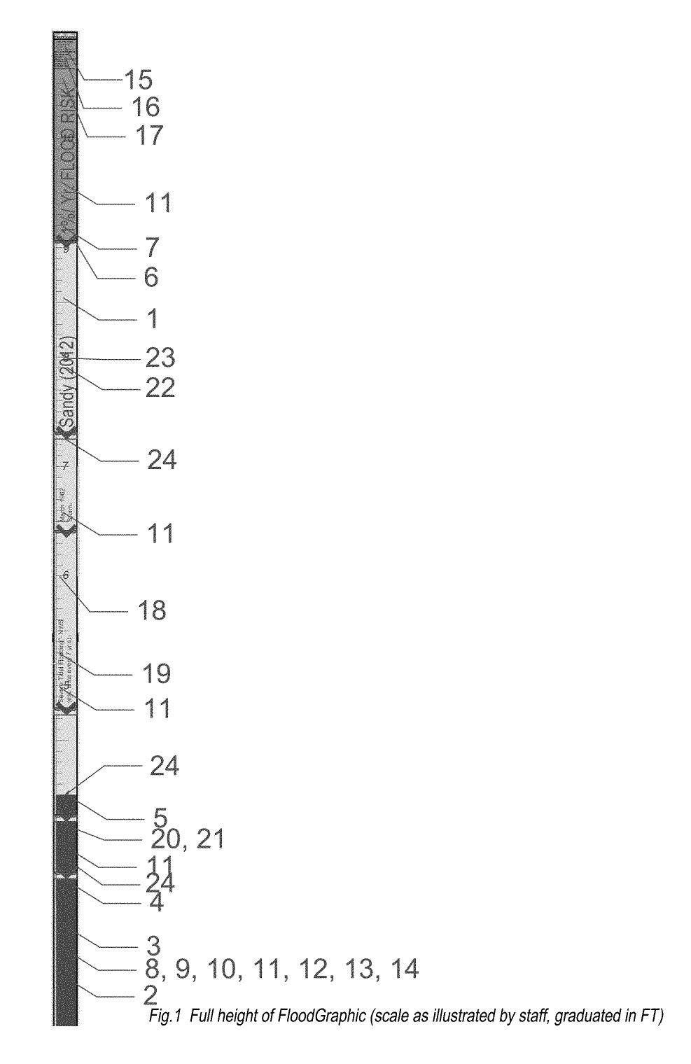

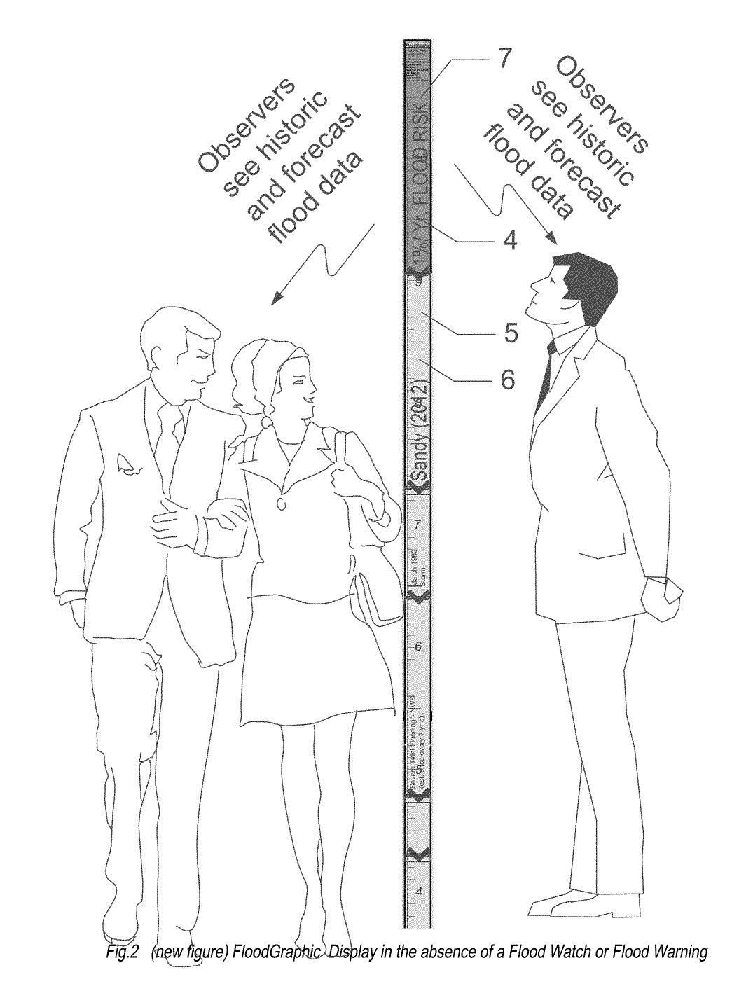

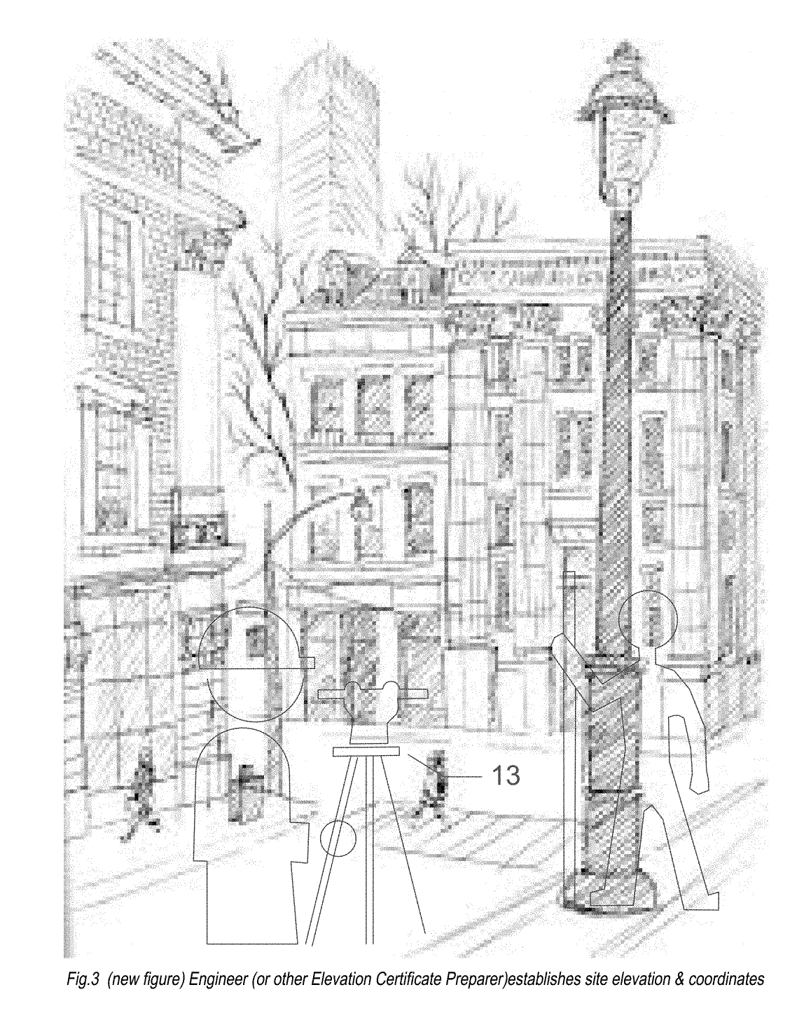

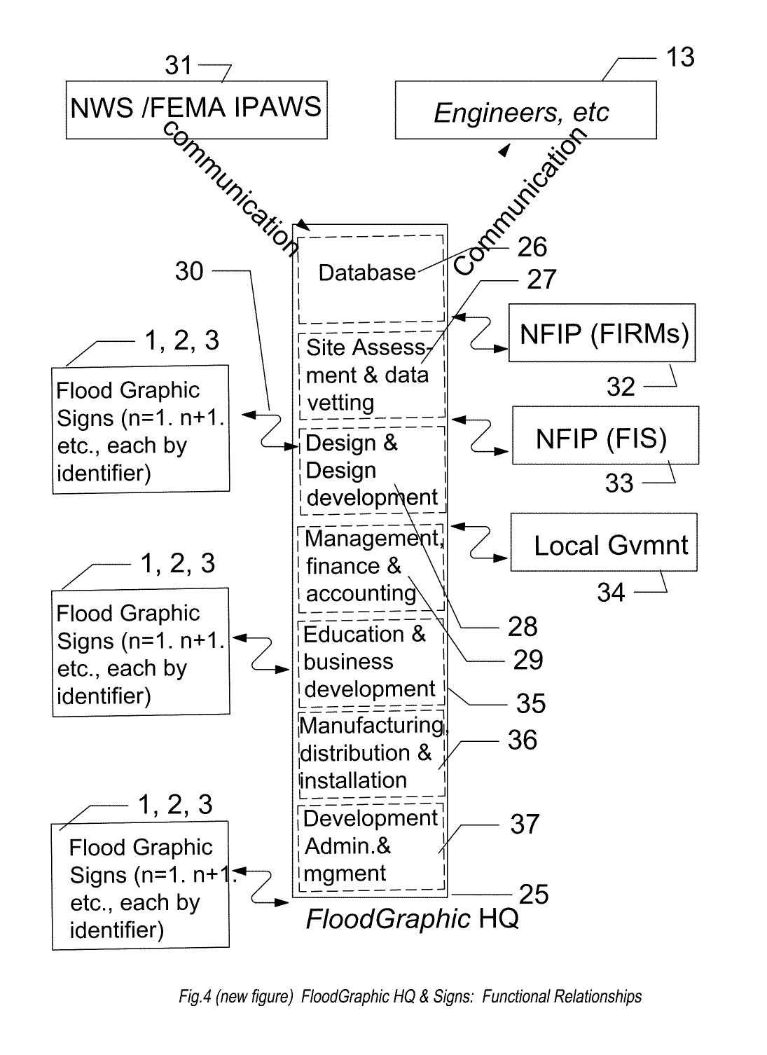

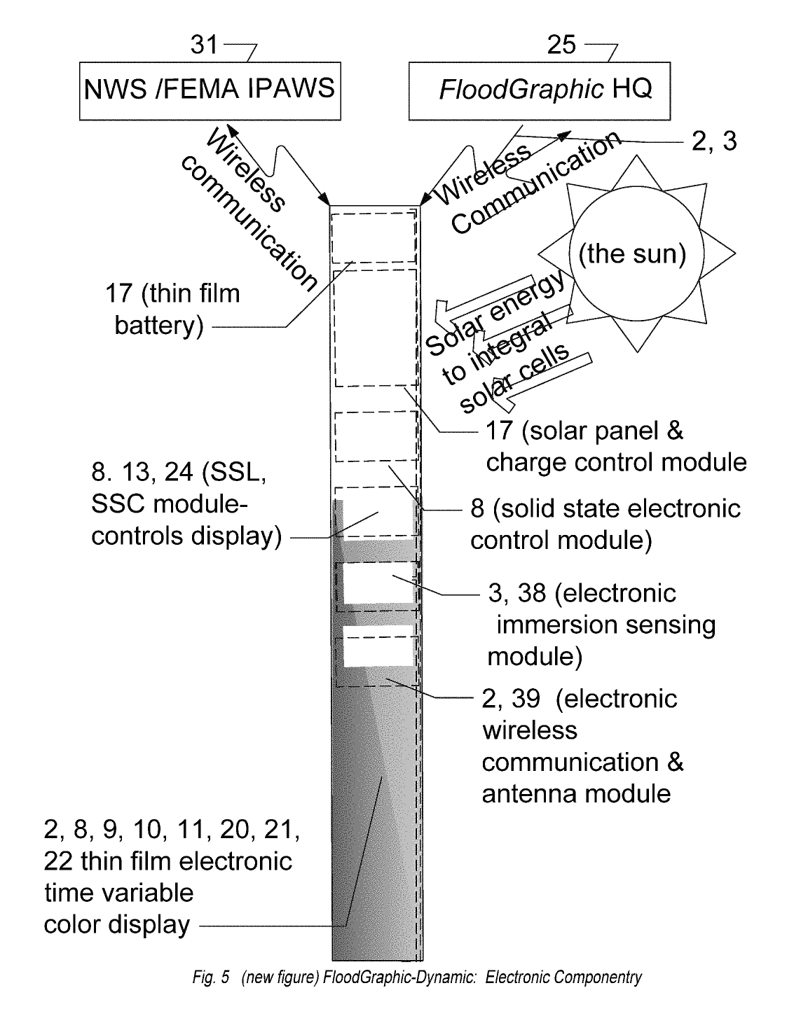

The signs (FIG. 1) are of consistent appearance as to shape and configuration regardless of location of installation. What changes from place to place is the height of the color transition (from yellow (below the 100 year flood) to green (above the 100 year flood), the text, and graphics. The height above the ground of the yellow color presents the most obvious and perceptible representation of a high degree of flood risk. The higher the yellow color, the greater the risk. If the yellow color projects only a short distance above the ground and the color of the sign is preponderantly green (above the color transition) this signifies a site of relatively low degree of flood risk. The color change from yellow to red in the event of flood watches and warnings extends upward from the ground to the elevation of the forecast flood in the FloodGraphic-dynamic version of the signs. Design development will achieve the appearance and described functionality of the signs.

The invention comprises, in addition to the signs, the organization and mechanics by which the implementation of the method can be effected.

The signs are the devices by which flood hazard information, to include government issued flood watches and warnings are visually communicated to persons in flood prone communities where an array of such signs has been installed at such geographic locations as to highlight the variability of flood risk attributable to multiple parameters, but preponderantly variability in topography within small areas

Implementation of the signs: FloodGraphic Headquarters (FG HQ)

FG HQ is the means by which the actual visual warning system comprising the array of FG signs will be implemented.

The method of the FloodGraphic visual warning system includes FloodGraphic headquarters, an organization which performs Design development to achieve the appearance and described functionality of the signs.

FG HQ will be a large vertically integrated technology organization with the capacity to perform the design development, cost estimating, solicitation of capital, and implementation of the FG program. Once operational, the large vertically integrated technology organization may discharge operations to a government agency. Multiple tasks must be performed by FG HQ, as follows.

Funding is to be by Beneficiaries

Ultimately, beneficiaries will fund installation of the signs. Beneficiaries, e.g. insurance companies, FEMA, NFIP, are motivated by prospective savings that will accrue as a consequence of loss reduction and the public health and safety benefits that will accrue. FG HQ will present the FG program to beneficiaries and solicit funding to bring the method to fruition.

Design Development of the Signs

The initially deployed array of FG signs may be the static version, and could be accomplished with paint and a paint brush on an appropriate blank, but more likely would be printed on a vinyl appliqué appropriate for shipment from FG HQ or its contractors to entities in the field for mounting on any suitable substrate.

The FG-D sign is an electronic device incorporating multiple modern technologies most if not all of which are protected by patents and will require licenses to issue to enable their use. Electrical and electronics engineers well-versed in the technologies described must perform designs to bring the invention to fruition. The designs must be tested and proven functional. Necessary patent licensing must take place. The mechanics of production, industrial engineering, manufacturing design and the like must be determined. Cost estimating must be performed. The envisioned final form will be a thin film electronic membrane suitable for rolling into a small cylindrical form for ease of shipment by FG HQ to entities in the field for mounting on any suitable substrate.

Approvals Acquisition

Prior to installation of any sign on public or private property, approvals must be obtained from owners. Compliance with all relevant laws and regulations must be demonstrated.

Financing the Program

At the outset, initial capital must be obtained to advance the program. Once all relevant information and limitations that establish implementation costs are in hand, funding for implementation must be identified and actual funds brought into the program.

Development of Database

There is a plethora of data available in our society that will facilitate and expand the presentation of specific data at each FG location. That data must be sourced and organized in an appropriate database such that each proposed installation might efficiently and systematically benefit. Data mining of all available resources using best technologies is necessary to accomplish this task. Upon implementation of FG-D, the FG system itself will continuously expand the database as flooding occurs over time and is detected and reported by the array of FG-D signs.

Operational Plan

Tasks performed by FG HQ include identification of participants in the program by category, education of prospective participants as to their envisioned roles and related compensation, ascertainment of fees necessary for prospective participants to be motivated to perform the roles envisioned for them, and recruitment of participants.
Professionals in the Flood Certification business are prospective vendors as to identification of installation sites and final observation of installations to include initialization and reporting of installed signs. A two-tiered fee system is envisioned whereby each proposal for an installation is a compensated service. Flood certification professionals at time of survey for preparation of a Flood Elevation Certificate are in the field and equipped to provide the necessary data for identification of appropriate sites for FG sign installation.
FG HQ by virtue of its depth of talent and vertical integration will be capable of performance of all other necessary tasks to implement the FG program. It will require cooperation of government agencies and private parties at every level to achieve the database of historic flooding and flood hazard zones.

Description of the Figure(s) of the Drawings The FloodGraphic signs are shown in FIG. 1 and is further described in the reference characters 1-24 below. FIG. 2 depicts a FloodGraphic sign as might be viewed by passersby in a flood prone community, reference characters 4, 5, 6, & 7. FIG. 3 depicts diagrammatically field surveyors in a flood prone community determining elevations at a lamppost, a prospective site for installation of a FloodGraphic sign, reference characters 13. The FloodGraphic-dynamic signs are further depicted in FIG. 5, reference characters 2, 8, 9, 10, 11, 20, 21 and 22. FloodGraphic Headquarters is depicted in FIGS. 4 and 5, reference characters 25-39. Below are listed all reference characters.
1) A printed and/or adhesive-backed vinyl (or other appropriate material in the case of FG-D) surface applied to an appropriate sign substrate sheet, approximately 3 in. in horizontal dimension by approximately 10 ft. in vertical dimension, displaying location-sensitive topographic and flood hazard data, affixed to an aluminum, plastic, or other suitable sign blank material substrate of consistent dimension. FG-D is similar in appearance to FG until the event of a Flood Watch or Flood Warning which events precipitate video display.
2) FG-D is internally illuminating, and presents variable color and text in response to two-way electronic wireless communication from FG HQ. These features are not visible in a static drawing.
3) FG-D reports to FG HQ on experienced flooding detected through the immersion sensing properties of FG-D. This feature is not visible as the electronics are embedded in the sign.
4) Font, text and graphics are designed to be viewable and comprehensible by pedestrians in the built environment. In the event of a locale intended to be readable by motorists, the width and size of text will increase as appropriate to achieve legibility,
5) The background color (yellow) and border (black, ⅜″ wide) emulate the standard for Warning signs specified in the US DOT Manual of Uniform Traffic Control Devices, so as to take advantage of the community recognition of the aesthetic already associated with warning signs.
6) The body sign color is yellow below 100 yr/1% annual risk of flood. The background color is yellow below the Base Flood Elevation (BFE) as established by the Flood Insurance Rate Map (FIRM) for the site by FEMA, to associate the portion of the sign below the elevation of the 100 year flood as a prospective range of flooding.
7) The body sign color is green above 100 yr/1% annual risk of flood, signifying reduced risk.
8) FG-D, by virtue of incorporation of Solid-state lighting (SSL) and Solid State Electronic Control (SSC), has the capacity to present internal illumination, including dynamic illumination, to present the illusion of rising water by transformation of the color of the bottom portion of the sign, from the grade level up to the forecast flood elevation, from yellow to red over a selected time interval. Time intervals described are subject to adjustment based on experience. These features are not visible, as the electronics are embedded in the sign, and the lighting and dynamics cannot be presented in a static drawing.
9) For flood watches the default time interval for the color transition from the base of the sign up to the elevation of the forecast flood is 5 seconds and is followed by an immediate return of the transformed color red back to yellow. Thereafter there is a 5 second time interval wherein the body color within the range of forecast flooding is yellow. Then the transformation from yellow to red, from grade level to the elevation of the forecast flood, repeats in another 5 second interval. These features are not visible, as the electronics are embedded in the sign, and the lighting and dynamics cannot be presented in a static drawing.
10) In the case of Flood Warnings, the transition from yellow to red is as in the case for Flood Watches, with the addition of a rapid 0.5 second pulsation of the color of the sign within the forecast range of flooding from yellow to red over a 5 second interval, after which the color of the sign within the range of forecast flooding returns to yellow for 5 seconds, and therafter for the duration of the Flood Warning the cycle repeats—a 5 second upward transition from yellow to red, 5 seconds of 0.5 seconds duration of pulsation from yellow to red over the forecast vertical flood interval on the sign, and a return to yellow for 5 seconds, after which the cycle repeats.
11) Data is presented via text and graphics. FG indicates the Base Flood Elevation as well as the elevation of historic floods, and established warning elevations, in full scale. The key feature is that the elevation of the site corresponds to the beginning of the graduations shown on the sign; e.g., a FG sign at a location where the grade level is 5.0′ NVGD will have the 1^{st} foot mark 1′ above the ground and it will be annotated “6”, while a FG sign a block away, where the grade level is 8′ NVGD will have the 1st foot mark 1′ above the ground and it will be annotated “9”. If the 100 year flood in the area incorporating the two FGs in this example is 10′ NVGD, the yellow-green transition line will be 5′ above the ground in the 1^{st} example, but only 2′ above the ground in the 2^{nd} example.
12) The variation in height above the ground of the yellow to green transition line will serve to educate the public about the variations in topography within a given food area and demonstrate the relative danger levels. This relationship will be evident in all prospective flood locales, coastal as well as riverine.
13) Data is site location and elevation dependent. Professional Land Surveyors, Engineers, and/or any party authorized to prepare FEMA Flood Elevation Certificates determine the elevation at grade of the installation and the particulars of the installation site, e.g., sign post, building corner, and submit the information to FG HQ as a proposal for installation of a FG sign. Upon acceptance of the proposal, FG HQ prepares the FG using graphic design/drafting software and data retrieved and vetted from private and Government sources, and prints the sign face for installation at the specific locale in consideration. It is then adhesively installed by any party on an appropriate locally sourced substrate, the substrate affixed in accordance with local standards, under supervision of the party who determined the site location and elevation data and proposed the installation.
14) It is assumed that the design development of FG-D will lag that of FG. FG-D may simply be furnished as an overlay to initially installed FGs.
15) FloodGraphic logo, copyright & mask works notice, PAT PEND warnings.
16) Attribution/installer identification.
17) Printed circuit electronic controller, solar panel & battery (integrated into the FG-D print-not visible).
18) Graduated staff, marked to display full 1 FT (or 1 M) increments with numerals, 0.1 FT (or M) increments with short tics, 0.5 FT (or M) increments with medium tics. Each FG is set at each site so the gradations (numeric elevations) accurately present site-specific elevations to NAVD 88 (or other National Standard) for each location of FG installation. Each FG displays text indicative of site-specific flood history and warnings relative to future flooding.
19) Flood warning or historic flood descriptive text, customized to present site-specific data. Specific historic floods are graphically indicated.
20) Sign Color transition at flood watch: Yellow or Yellow and Green transitions to red from the bottom of the sign up to the elevation of the specific flood watch over a 5 second period, followed by a 5 second interval over which the original colors are displayed, and subsequently followed again by the color transition from the bottom of the sign up to the elevation of the specific flood watch from Yellow or Yellow and Green to red, in a repeating fashion.
21) Sign Color transition at flood warning: Yellow or Yellow and Green transitions to red progressively from grade and the base of the sign up to the elevation of a specific flood warning, from the bottom of the sign up to the elevation of the specific flood warning over a 5 second period of time, followed by 5 flashes of the red color in a 5 second period of time over the vertical space interval above-described, and then followed by a final 5 second interval over which the original colors are displayed, and subsequently followed again by the two phases of color transition from Yellow or Yellow and Green to red, as above described, in repeating fashion.
22) Flood warning or historic flood descriptive text. Variable, and dependent on specific location. Data is determined by “FG HQ” from Government sources.
23) Numeric indication of actual elevation of mark on staff, to NAVD 88.
24) FloodGraphic level symbol (typical). Depicts a historic or forecast flood level, specific to each location of FG installation. Multiple repetitions present different historic or forecast flood levels. FG-D is Electronically illuminated with printed Flexible OLED light. Graduations and elevation numerals reflect actual NAVD 88 elevations, which vary at each installation.
25) Graphic depiction of FloodGraphic Headquarters, and certain of the internal processes of original claims 2 & 3.
26) Graphic depiction of the database created and maintained by and within FG HQ as claimed in original claims 2 & 3.
27) Graphic depiction of the site assessment and vetting process performed within FG HQ as claimed in original claims claim 2c renumbered as within claim 2.
28) Graphic depiction of the design and design development process by and within FG HQ as claimed in original claims claim 2a renumbered as within claim 2.
29) Graphic depiction of the management, finance and accounting processes by and within FG HQ as claimed in original claims claim 2b renumbered as within claim 2.
30) Graphic depiction of the wireless communication between the FG-Dynamic signs and FG HQ as claimed in original claims claim 2c, 17 & 18 renumbered as within claims 2, 17 and 18.
31) Graphic depiction of the US government's National Weather Service (NWS), Federal Emergency Management Agency (FEMA) and FEMA's Integrated Public Alert & Warning System (IPAWS) as communicated with by FG HQ as to flood watches, flood warnings, sensed levels of flooding and predicted and historic flood elevations frequencies as claimed in original claims claim 2c renumbered as within claim 2.
32) Graphic depiction of the US government's National Flood Insurance Program (NFIP) Flood Insurance Rate Maps (FIRMs), a data source utilized by FG HQ in sourcing the reference datum and elevation of the 100 year flood for display on the FloodGraphic signs as claimed in original claims claim 2c renumbered as within claim 2.
33) Graphic depiction of the Flood Insurance Studies (FIS) prepared for participating communities in the US government's National Flood Insurance Program (NFIP), a data source utilized by FG HQ in sourcing the predicted and historic flood elevations frequencies displayed on the FloodGraphic signs as claimed in original claims claim 2c renumbered as within claim 2.
34) Graphic depiction of the local governments of participating communities in the US government's National Flood Insurance Program (NFIP), a data source utilized by FG HQ in sourcing the predicted and historic flood elevations and frequencies displayed on the FloodGraphic signs as claimed in original claims claim 2c renumbered as within claim 2
35) Graphic depiction of the education & business development process performed within FG HQ as claimed in original claims claim 2b renumbered as within claim 2.
36) Graphic depiction of the manufacturing distribution and installation process performed within FG HQ as claimed in original claims claim 2b renumbered as within claim 2.
37) Graphic depiction of the management, finance & accounting process performed within FG HQ as claimed in original claims claim 2b renumbered as within claim 2. 38: Graphic depiction of the electronic emersion sensing device(s) as claimed in claim 6.
38) Graphic depiction of the electronic wireless communication device(s) as claimed in original claims claim 1b, 17 & 18 renumbered as claims 1, 17 & 18.
39) Graphic depiction of the electronic antenna module which module facilitates wireless communication between the FloodGraphic signs and FloodGraphic headquarters as claimed in claim 7

The claims defining the invention are as follows:

1) a method for visually providing to individuals in flood prone communities historic flood information, the level of the 100 year recurrence interval flood as forecast by the US Federal Emergency Management Agency and to automatically display flood watches and warnings as issued by the US National Weather Service, in an accurate spatial relationship to the ground level at each of an array of specific sites, wherein the method comprises:
The outdoor display in communities of special hazard of an array of signs, titled FloodGraphic and FloodGraphic-Dynamic, indicating elevations of historic and future floods relative to the North American Vertical Datum (NAVD) at the point of installation of each sign as established by a state-licensed Professional Engineer, architect, or Land Surveyor on a graduated full scale post or pole, particularly and consistently annotated with text and variable colors (red, yellow, black, and green) to emphasize variable flood risk frequencies and site specific elevations in the North American vertical datum (NAVD) or in the National Vertical Geodetic Datum where either such datum is in use in Flood Insurance Rate Maps issued by the Federal Emergency Management Agency,
and incorporation of standardization in the sign design and functionality to facilitate its deployment in consistent format throughout the USA, thereby establishing a standardized, readily recognizable warning device.

2) the method of claim 1, whereby the information displayed on the signs is provided by a centralized /headquarters organization which:
Performs Design Development for the FloodGraphic and FloodGraphic-Dynamic Signs,
develops the specifics of the incorporated technologies, to include
printing stock & methods for FG,
printing stock & methods for FG-D,
Electronics design and licensing of incorporated technologies and services,
cost estimating,
manufacturing, distribution & installation costs, and
performs administration, development, & management for the FloodGraphic and FloodGraphic-Dynamic Signs,
educates prospective beneficiaries and service providers/ vendors as to the existence, mechanics and prospective benefits of the program, seeks blanket/bulk approvals from governmental agencies for installations; e.g., state/county/local governments,
seeks amendments to FEMA's prototype Community Floodplain Management Ordinance that meets or exceeds the minimum NFIP criteria to authorize FG & FG-D on municipal property after review by a designated official,
accumulates, vets and qualifies historic flood data for flood-prone areas and tabulates the data in a database searchable by latitude and longitude,
defines necessary implementation services & related Consultant fees payable in the implementation of FloodGraphic and FloodGraphic-Dynamic signs, including:
site Identification & Proposal of Installation; e.g., to a preparer of a FEMA Flood Certificate, the proposing engineer, surveyor or architect or similarly qualified party who submits a Proposal of a site for FG &/or FG-D installation,
aggregation and evaluation of requests for installation of FloodGraphic and/or FloodGraphic-Dynamic signs through vetting of Proposals as above, to include extraction of appropriate data from the database to be presented on FG sign and type of sign to be installed; e.g., to FG HQ or a qualified Subcontractor, layout production and transportation of the sign e.g., to FG HQ or a qualified Subcontractor,
receiving and Installation of the sign blank and sign face by the installer, e.g. a local county or state highway department,
observation, verification, initialization and reporting of completed installation by the proposing engineer, surveyor or architect,
i) performs cost accounting, billing and reporting financial results, performs cost estimating/ budgeting of necessary implementation services,
defines of required Revenues to support implementation
identifies & solicits prospective sources of revenue (“beneficiaries”),
contracts with beneficiaries for the income stream to support implementation,
contracts with vendors analyzes of program costs & benefits
prepares proposals for modifications to improve program costs & benefits,
aggregates and evaluates historic data and warning data, manages data selection, production, delivery and installation of FloodGraphic and or FloodGraphic-Dynamic signs, communicates flood watches and warnings to the signs receives flood data from the signs, updates the display on the signs based on historic events and changes in the elevation of the 100 year flood as may be determined/dictated by FEMA, and maintains a record of installation and data on and received from each sign.

3) The the method of claim 1, whereby the centralized database/headquarters as claimed in claim 2 is charged with accumulation and retention of location of installations of the sign as claimed in claim 1 and historic flood records detected and reported as in claims 10-19, inclusive.

4) the method of claim 1 whereby the signs as claimed in claim 1 further comprise the use of color to distinguish between elevations above and below the 100 year flood as established by The Flood Insurance Rate Maps of the National Flood Insurance Program.

5) The method of claim 1, whereby the signs as claimed in claim 1 further comprise utilization of wireless intercommunication capabilities with the centralized database/headquarters of claim 2.

6) The method of claim 1 whereby the signs as claimed in claim 1 further comprise the ability to detect and record static and dynamic depths of flooding at its location through electronic pressure measurement, electrical resistivity measurement, or other electronic means.

7) the method of claim 1 whereby the signs as claimed in claim 1 further comprise and are capable of presentation of a variable message display, dependent upon inputs from the centralized database/headquarters of claim 2 via wireless communication.

8) The method of claim 1 whereby the signs as claimed in claim 1 further comprise the capability to present variable time-sensitive color displays via Solid-state lighting as described in this Specification with such displays being indicative of Flood Watches and/or Flood Warnings as issued by the National Weather Service or equivalent, to a specific elevation.

9) the method of claim 1, whereby the signs as claimed in claim 1 further comprise the ability to present variable displays indicative of changes in historic floods.

10) the method of claim 1 whereby the signs as claimed in claim 1 further comprising the ability to present variable time-sensitive color displays indicative of changes in future flood warnings, e.g., revisions in Government flood insurance rate map (FIRM) 100 year floods.

11) the method of claim 1 whereby the signs as claimed in claim 1 further comprising the ability to present a variable color display, transitioning from yellow to red, from the bottom of the sign at grade level to the elevation of a forecast flood over a period of seconds of time in repetitious fashion as a means of an announcement of imminent flood warning to the level indicated by the uppermost extent of the red color as described in this Specification.

12) The method of claim 1 whereby the signs as claimed in claim 1 further comprise the ability to consist of a printed electronic surface incorporating Solid-state lighting.

13) The method of claim 1 whereby the signs as claimed in claim 1 further comprise the ability to utilize organic field-effect transistors, organic light-emitting diodes and integrated circuits to achieve the variable display.

14) The method of claim 1 whereby the signs as claimed in claim 1 further comprise the ability to incorporate and utilize a solar panel or organic photovoltaic cells & battery.

15) The method of claim 1 whereby the sign as claimed in claim 1 further comprises the ability to incorporate and utilize integrated control circuits.

16) The method of claim 1 whereby the signs as claimed in claim 1 further comprising the ability to incorporate and utilize electroluminescent multicolor displays to achieve the variable display.

17) The method of claim 1 whereby the signs as claimed in claim 1 further comprise the incorporation of radio-frequency identification.

18) The method of claim 1 whereby the signs as claimed in claim 1 further comprising the incorporate ability to Automatic Identification and Data Capture.
